(19) United States
(12) Patent Application Publication
(10) Pub. No.: US 2016/0232738 A1
(43) Pub. Date: Aug. 11, 2016

(54) GAME AND GAMING MACHINE HAVING TIC-TAC-TOE TYPE FEATURE

(71) Applicant: Terence G. Daly, Las Vegas, NV (US)

(72) Inventor: Terence G. Daly, Las Vegas, NV (US)

(21) Appl. No.: 14/990,914

(22) Filed: Jan. 8, 2016

Related U.S. Application Data
(60) Provisional application No. 62/102,027, filed on Jan. 11, 2015.

(51) Int. Cl. G07F 17/32; G07F 17/34

(52) U.S. Cl. CPC G07F 17/326; G07F 17/3213; G07F 17/34

(57) ABSTRACT

A gaming machine including a controller is provided. The controller is configured to provide a base game and provide a tic-tac-toe game board, the tic-tac-toe game board comprising a plurality of spaces. The controller is further configured to identify, based at least in part on an outcome in the base game, one or more moves to be made on the tic-tac-toe game board, and place one or more tic-tac-toe symbols in spaces on the tic-tac-toe game board based on the identified moves to be made such that if the space includes a previously-placed tic-tac-toe symbol, the previously-placed tic-tac-toe symbol is replaced. The controller is further configured to determine if the tic-tac-toe game board includes a winning outcome.

### RELATED APPLICATION DATA

This application claims priority to U.S. Provisional Application Ser. No. 62/102,027, filed Jan. 11, 2015.

### FIELD OF THE INVENTION

The present subject matter relates to games and gaming machines configured to present games.

### BACKGROUND OF THE INVENTION

As gaming continues to grow in popularity, game players seek new and exciting ways to play games and interact with gaming machines.

Known games may include a primary game, such as spinning reels or video poker. A secondary, or bonus, game may provide additional interactions or opportunities to win money or prizes. Secondary games may offer winning outcomes that are cumulative of game plays of the primary game. Thus, as a player plays more rounds of the primary game, regardless of the outcome of the primary game, the player may be receiving additional opportunities for winning outcomes in the secondary game. The secondary game therefore provides a source of excitement and opportunity for winning that may entice the player to continue playing the primary game.

Accordingly, there is a need for games and gaming machines that have new secondary games that will provide additional winning opportunities and excitement during gameplay.

### SUMMARY OF THE INVENTION

In one embodiment, a gaming machine comprising a controller is provided. The controller is configured to provide a base game, provide a tic-tac-toe game board that comprises a plurality of spaces, and identify, based at least in part on an outcome in the base game, one or more moves to be made on the tic-tac-toe game board. The controller is further configured to place one or more tic-tac-toe symbols in spaces on the tic-tac-toe game board based on the identified moves to be made such that if the space includes a previously-placed tic-tac-toe symbol, the previously-placed tic-tac-toe symbol is replaced, and determine if the tic-tac-toe game board includes a winning outcome.

In another embodiment, a machine-implemented method of presenting a game at a gaming machine is provided. The method includes providing a tic-tac-toe game board that comprises a plurality of spaces, accepting a wager from at least one player to play a game, and spinning, after accepting the wager, a plurality of reels that each include a plurality of symbols. Each of the plurality of symbols is in a position on the plurality of reels, and each position corresponds to a space on the tic-tac-toe game board. The method further includes identifying one or more moves to be made on the tic-tac-toe game board based on the position of each symbol on the plurality of reels, placing one or more tic-tac-toe symbols in spaces on the tic-tac-toe game board based on the identified moves to be made such that if the space includes a previously-placed tic-tac-toe symbol, the previously-placed tic-tac-toe symbol is replaced, and determining if the tic-tac-toe game board includes a winning outcome.

In yet another embodiment, a machine-implemented method of presenting a game at a gaming machine is presented. The method includes providing a tic-tac-toe game board that comprises a plurality of spaces, providing at least one bingo card bearing numbers or other designations associated therewith, and drawing at least one first set of bingo balls having associated numbers or designations and comparing the bingo balls to the numbers or designations associated with the bingo card. The method further includes identifying one or more moves to be made on the tic-tac-toe game board based on the at least one first set of drawn bingo balls, placing one or more tic-tac-toe symbols in spaces on the tic-tac-toe game board based on the identified moves to be made such that if the space includes a previously-placed tic-tac-toe symbol, the previously-placed tic-tac-toe symbol is replaced, and determining if the tic-tac-toe game board includes a winning outcome.

In yet another embodiment, a machine-implemented method of presenting a tic-tac-toe type event is provided. The method includes providing a tic-tac-toe game board that comprises a plurality of spaces, and identifying one or more moves to be made on the tic-tac-toe game board based on at least one randomly generated outcome, wherein each of the one or more moves includes a selection of a tic-tac-toe symbol and one of the plurality of spaces. The method further includes placing one or more tic-tac-toe symbols in spaces on the tic-tac-toe game board based on the identified moves to be made such that if the space includes a previously-placed tic-tac-toe symbol, the previously-placed tic-tac-toe symbol is replaced and determining if the tic-tac-toe game board includes a winning outcome.

Further objects, features, and advantages of the present invention over the prior art will become apparent from the detailed description of the drawings which follows, when considered with the attached figures.

### BRIEF DESCRIPTION OF THE DRAWINGS

FIG. 1 illustrates an exemplary gaming machine;

FIG. 2 is a flow chart of an exemplary method for use with the gaming machine of FIG. 1; and

FIG. 3 illustrates a gaming machine implementing a game of the present invention.

### DETAILED DESCRIPTION OF THE INVENTION

In the following description, numerous specific details are set forth in order to provide a more thorough description of the present subject matter. It will be apparent, however, to one skilled in the art, that the methods and systems described herein may be practiced without these specific details. In other instances, well-known features have not been described in detail so as not to obscure the subject matter.

Embodiments of the subject matter comprise methods of playing and presenting games. One embodiment comprises a game having a tic-tac-toe type feature. Other embodiments comprise gaming machines and gaming systems that are configured to present the games described herein.

In one preferred embodiment, a game has a base game feature and a secondary or bonus game feature. The secondary or bonus game feature comprises a tic-tac-toe type event. As detailed, the base game may comprise a wagering game such as a bingo game, slot game, video poker game, or other game.

In the exemplary embodiment, the plays made in the tic-tac-toe type event, or game, are determined by outcomes in the base game and awards may be given to the player as a result of winning outcomes in the tic-tac-toe game. The tic-tac-toe game includes a game board that displays the cumulative plays made and is generally grid-like. As the base game is played, symbols generated by the base game are placed on the tic-tac-toe game board. Unlike traditional tic-tac-toe games, symbols on the tic-tac-toe game board may be replaced by subsequent plays. Thus, the tic-tac-toe game board may be very dynamic, with one or more symbols being placed and/or replaced in each round.

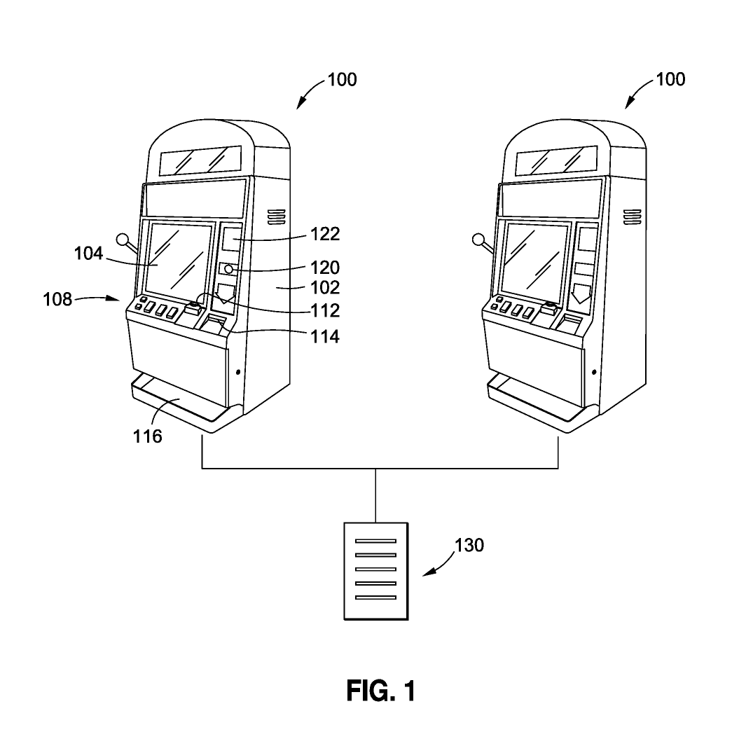

In a preferred embodiment, the methods of game play and presentation are implemented via a gaming machine or device 100, such as shown in FIG. 1. Such a gaming machine 100 may have various configurations.

The gaming machine 100 may be located at a casino (and as such is referred to as a “casino gaming machine”). As described below, the gaming machine 100 may be part of a gaming system, such as a casino gaming system which links multiple of the gaming machines, one or more table games and other devices such as kiosks, accounting systems or servers, progressive systems or servers, player tracking systems or servers or the like.

One configuration of a gaming machine 100 is illustrated in FIG. 1. As illustrated, the gaming machine 100 generally comprises a housing or cabinet 102 for supporting and/or enclosing various components required for operation of the gaming machine. In the embodiment illustrated, the housing 102 includes a door located at a front thereof, the door capable of being moved between an open position which allows access to the interior, and a closed position in which access to the interior is generally prevented. The configuration of the gaming machine 100 may vary. In the embodiment illustrated, the gaming machine 100 has an “upright” configuration. However, the gaming machine 100 could have other configurations, shapes or dimensions (such as being of a “slant”-type, “bar-top” or other configuration as is well known to those of skill in the art).

The gaming machine 100 preferably includes at least one display device 104 configured to display game information. The display device 104 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 104 may be capable of projecting or displaying a wide variety of information, including images, symbols and other indicia or information associated with game play, game promotion or other events. Of course, the gaming machine 100 may include more than one display, such as two or more video displays. For example, in one embodiment the gaming machine 100 might include a first video display, such as used to display base or main game information, and one or more second video displays, such as used to display secondary game or event information. Each such video display may be associated with the housing of the gaming machine 100. In other embodiment, one or more of the displays might be associated with a top box, bank display or the like.

As described in more detail below, the gaming machine 100 is preferably configured to present one or more games upon a player making a monetary payment or wager. In this regard, as described in more detail below, the gaming machine 100 includes means for accepting monetary value.

In one embodiment, as detailed above, certain game outcomes may be designated as winning outcomes. Prizes or awards may be provided for winning outcomes, such as monetary payments (or representations thereof, such as a prize of credits), or promotional awards as detailed herein. As detailed below, the gaming machine 100 includes means for returning unused monetary funds and/or dispensing winnings to a player.

The gaming machine 100 preferably includes one or more player input devices 108 (such as input buttons, plunger mechanisms, a touch-screen display, joystick, touch-pad or the like). These one or more devices 108 may be utilized by the player to facilitate game play, such as by providing input or instruction to the gaming machine 100. For example, such input devices 108 may be utilized by a player to place a wager, cause the gaming machine 100 to initiate a game, to indicate cards to be held or discarded, to “cash out” of the gaming machine, or to provide various other inputs.

In one preferred embodiment, the gaming machine 100 includes at least one microprocessor or controller (not shown) for controlling the gaming machine, including receiving player input and sending output signals for controlling the various components of the machine 100 (such as generating game information for display by the display 104). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 104 (such as information representing images of slot symbols, tic-tac-toe symbols and the like), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 100 may also include one or more random number generators for generating random numbers, such as for use in selecting bingo cards, bingo balls, slot symbols, tic-tac-toe symbols or other game information and for presenting the game in a random fashion.

Preferably, the controller is configured to execute machine readable code or instructions which are configured to implement the method of game play of the invention. For example, the controller of the gaming machine 100 may be configured to detect a wager, such as a signal from a player's depressing of the “bet one” button. Upon such an event and/or the player otherwise signaling the gaming machine to present the game, the controller may be configured to cause a base game to be displayed on the at least one display 104. The controller may accept input from a player of the base game via the one or more player input devices of the gaming machine 100. The at least one display 104 may be used to display some or all of a base game and/or a secondary game, such as the tic-tac-toe type event. For example, on a primary display, the base game may be displayed while the secondary game is displayed on a secondary display. Alternatively, both the primary game and the secondary game may be displayed on the same display.

The gaming machine 100 may be configured to generate and present games in a stand-alone manner or it may be in communication with one or more external devices at one or more times. For example, the gaming machine 100 may be configured as a server-based device and obtain game code or game outcome information from a remote game server (in which event the gaming machine controller may receive game information from the server, such as game outcome information, and use that server-generated information to present the game at the gaming machine).

As indicated, the gaming machine 100 is configured to present one or more wagering games. Thus, the gaming machines 100 is preferably configured to accept value, such as in the form of coins, tokens, paper currency or other elements or devices representing value such as monetary funds. For example, as illustrated in FIG. 1, the gaming machine 100 might include a coin acceptor 112 for accepting coins. Of course, associated coin reading/verifying devices and coin storage devices may be associated with the gaming machine 100 if it is configured to accept coins. Likewise, the gaming machine 100 might include a media reader 114. Such a reader may be configured to accept and read/verify paper currency and/or other media such as tickets. Of course, in such event the gaming machine 100 may further be configured with one or more paper currency or ticket storage devices, such as cash boxes, and other paper currency or media handling devices (including transport devices).

The gaming machine 100 might also be configured to read FOBs, magnetic stripe cards or other media having data associated therewith and via which value or funds may be associated with the gaming machine 100.

In one embodiment, the gaming machine 100 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 100 dispensing coins to a coin tray 116. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,1029 to Burns, which is incorporated herein in its entirety by reference.

The gaming machine 100 may also include a player tracking device, such as a card reader 120 and associated keypad 122. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, it is possible for the game of the invention to be presented on a computing device, including at a home or office computer. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

In another embodiment, the gaming machine 100 may include other types of displays. For example, the one or more displays might comprise one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. In other embodiments, such reels are implemented in software and are displayed by display 104. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

A casino may have numerous such gaming machines 100, such as located on a casino floor or in other locations. Of course, such gaming machines 100 might be used in other environments, such as an airport, a bar or tavern or other locations.

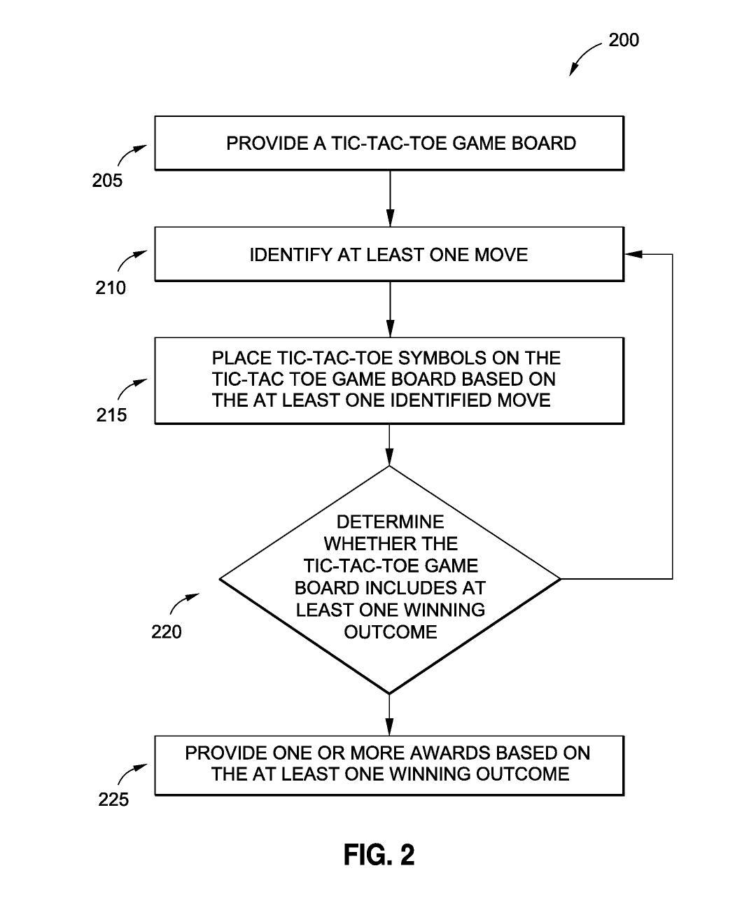

FIG. 2 is a flow chart 200 of a tic-tac-toe type event that may be presented via a gaming machine such as the gaming machine 100 illustrated in FIG. 1. The tic-tac-toe type event, or game, may be a primary game or event or a secondary game or event. For example, the tic-tac-toe event may be implemented as a primary game (e.g. the outcome of the event comprise a primary game outcome which may have one or more winning outcomes with associated primary awards) or as a secondary game or event (e.g. there is a primary or base game which may define one or more winning outcomes having associated primary awards and the tic-tac-toe game could define one or more secondary winning outcomes having associated secondary awards which may be separate from, including in addition to, the primary awards).

In the exemplary embodiment, plays made in the tic-tac-toe game are non-deterministic and automatic. In other words, unlike regular tic-tac-toe games, each move may be substantially random (or based upon a random event, such as a reel spin) and may be made without player selection. While playing tic-tac-toe may usually involve a stratagem, the tic-tac-toe game described herein may have an outcome determined by chance (although in other embodiments, the game may involve an element of skill) Moreover, unlike known tic-tac-toe games, the game described herein may be played by a single player who represents the two opposing sides (i.e., Xs and Os) in known games.

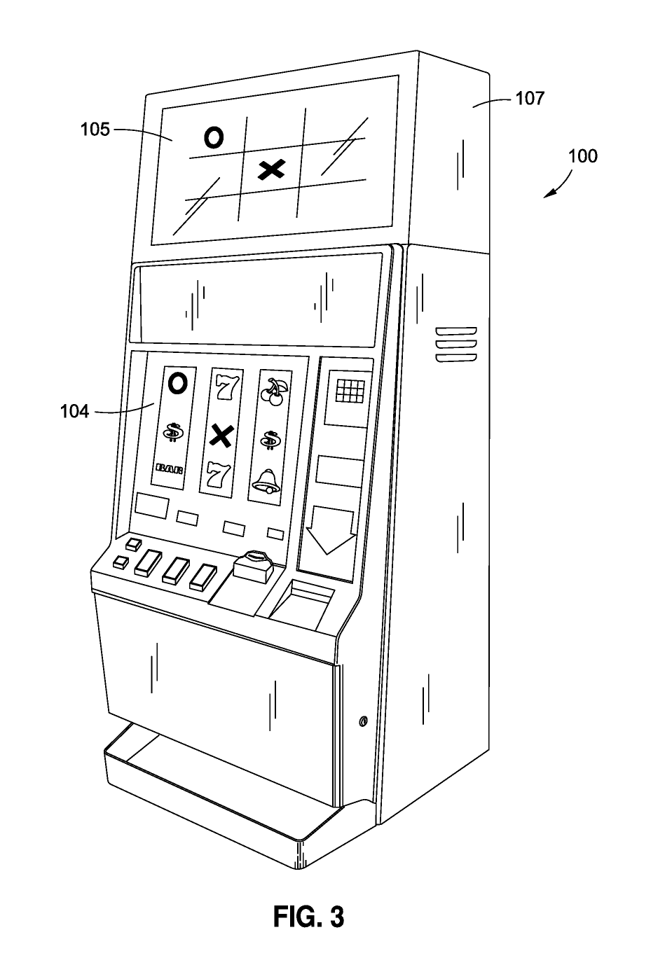

One embodiment of the invention will be described with reference to FIG. 2. A game begins in step 205 with providing a game board. The game board is typically grid-like, such as in known tic-tac-toe games. In some embodiments, the game board is a 3×3 grid, and in other embodiments the game board is a 2×2, 4×4, or other sized grid. Each of the component squares of the game board may be referred to as a “space.” In some embodiments, the game board is displayed, such as using a display of the gaming machine. As illustrated in FIG. 3, in one preferred embodiment, primary game information may be displayed on a main or base display 104 of the gaming machine and the tic-tac-toe grid and game may be displayed via a secondary display 105, such as associated with a top portion or top box 107 of the gaming machine. In such an embodiment, the game board or grid is preferably represented graphically. In other embodiments, it is possible for the game board or grid to include physical lines or dividers to demarcate the various spaces of the game board. One or more display areas within each space are configured to display a game state (e.g., a game symbol). The tic-tac-toe game described herein uses two or more game pieces or symbols to represent two or more sides in the game, for example, Xs and Os (though the game could be played using more than two sides or sets of symbols). Although more than one side may be represented in the tic-tac-toe game, the player may be rewarded for a winning outcome of any of the represented sides (though in other embodiments, a player may be required to select a side, such as “X” and is then only awarded for winning “X” outcomes).

During a step 210, at least one move is identified. A “move” or “play” refers to the placement of a game symbol on the game board. Thus, a move has at least two components: which game symbol to use and where to place it. In a typical game of tic-tac-toe, the symbol is determined by which player is making the move (i.e., player A uses Xs), and the placement is determined by the player. In the exemplary embodiment, the game symbol itself, the number of game symbols to place, and the placement may be randomly determined. In some embodiments, the game symbol, the number of game symbols, and/or the placement are determined by an outcome of, or determination by, a base game. In other embodiments, the game symbol, number of game symbols, and/or the placement are directly determined, such as by a random number generator associated with gaming machine 100.

For example, in a reel-based game, the reel symbols and position of the reel symbols may determine one or more moves. The reels may have traditional or primary symbols (e.g., cherries, 7s, themed symbols, wilds, etc.) as well as tic-tac-toe or secondary symbols. The secondary symbols may be displayed as part of the reel event or game, or be hidden behind the primary symbols and revealed after the outcome of the primary symbols is determined and/or processed (e.g., credits are paid for a winning set of primary symbols). More specifically, the reel-based game may have 5 reels that each have a playable or viewable area that is 3 symbols high, forming a 5×3 grid of symbols (of course, there might be other arrangement of reels or symbols, such as 3 reels which each display 3 symbols, thus resulting in a grid of symbols 3×3, etc.). As indicated above, in such a game the symbols might be displayed by physical reels or graphically via a video display. The player or machine causes the reels to be spun (physically or virtually) so as to result in the display of a set of reel symbols. One or more combinations of the symbols may be defined to be a winning combination of symbols. For example, the appearance of one or more symbols in certain positions (such as along designated paylines) may be considered to be winning and/or the appearance of one or more symbols in any position (i.e. a “scatter”) may be considered to be winning. A paytable may define the winning (vs. losing) combinations of symbols and one more awards which are associated with those winning combinations.

As indicated above, the primary symbols may include one or more secondary tic-tac-toe symbols or such symbols may be associated with the primary symbols. For example, one or more secondary symbols may be revealed by physically moving the primary symbol or by changing a display on which the primary symbol is shown. In some embodiments, the outcome of the primary symbols determines whether the secondary symbols are revealed. For example, the secondary symbols may only be revealed if the primary symbols do not produce a winning outcome, thus giving the player a second chance opportunity to win.

Continuing the example of a reel-based game, at least a portion of the grid of reels corresponds to the tic-tac-toe game board. In the case of a 5×3 grid, the center 3 reels may correspond to a 3×3 tic-tac-toe game board. A move is identified based on the secondary symbols and the position of each secondary symbol. For example, five reels (R1-R5) may display or reveal the following set of reel symbols which either include or have associated therewith (such as by revealing), the secondary X and O symbols as shown in Table 1. Notably, this combination of symbols might define a winning reel game outcome, such as by the result of the appearance of at least three “$” symbols.

TABLE 1

| R1 | R2 | R3 | R4 | R5 |
|---|---|---|---|---|
| $ | X | ♡ | ♦ | 7 |
| — | ♦ | 7 | $ | $ |
| ¤ | ♦ | 7 | O | $ |

In step 215, the secondary symbols are preferably used in the play of the tic-tac-toe game. In one embodiment, the secondary symbols are placed/shown on the tic-tac-toe game board based on the move or moves identified in step 210. The symbols placed on the tic-tac-toe game board may be the same or different than the secondary symbols on the reels. As indicated, the tic-tac-toe symbols may be placed into the tic-tac-toe game board in corresponding positions to their position in the reels (in this example, appearance of a secondary symbol on reels R2, R3 and R4 is used to determine the placement of the symbol into the tic-tac-toe grid). However, other placement configurations could be utilized (for example, secondary symbols might only be used if they appear in positions on reels R1, R3 and R5, or other variations). Continuing the example above, the tic-tac-toe game board may now appear as shown in Table 2.

TABLE 2

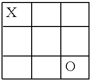

In step 220, the tic-tac-toe game board is analyzed to determine whether a winning outcome is present. A winning outcome may include a tic-tac-toe game board with three similar symbols in a row, whether horizontal, vertical, or diagonal—similar to known games of tic-tac-toe. Different possible winning outcomes may result in different awards. For example, during one game or round, three matching symbols across the top row may result in a cash award, while three matching symbols across the bottom row may result in a free hotel stay. The awards may change with each round of play (i.e., after one or more tic-tac-toe symbols are placed) and/or with each game (i.e., with each cleared game board). A description of the awards may be displayed to the user using display 104 such that winning outcomes are associated with possible awards. Multiple winning outcomes may result in multiple awards.

If at least one winning outcome is identified on the tic-tac-toe game board, the tic-tac-toe type event may be terminated after the appropriate awards are presented to the player. In other words, the tic-tac-toe game is over. The tic-tac-toe game board may be cleared and prepared for subsequent use by the same player or another player. Alternatively, the tic-tac-toe symbols used to produce the winning outcome may be cleared so those spaces are empty, but other spaces continue to display any previously displayed symbols.

If no winning outcome is identified on the tic-tac-toe game board, subsequent moves may be identified in step 210. In the example of the reel-based game, the player or machine may cause the reels to be spun again, producing different secondary symbols. During subsequent moves, one or more symbols on the tic-tac-toe game board may be replaced by a different symbol. Thus, symbols are placed on the tic-tac-toe board until replaced or the game ends (i.e., because of a winning outcome or because the player quits). This is different than known versions of tic-tac-toe, where a symbol cannot be changed during play. Accordingly, it is possible that a game board on the verge of a winning outcome may be set back by a replacement of one or more symbols. Because the course of the tic-tac-toe game is not merely linear (i.e., filling up the game board one space at a time until the game concludes), there may be additional excitement as a player's progress in the game moves closer to and further away from winning outcomes.

Continuing the example of a 5×3 grid of reels above, if the reels reveal secondary symbols in the same positions as existing symbols on the tic-tac-toe game board, they may be replaced. Table 3 illustrates a possible set of secondary symbols on the reels.

TABLE 3

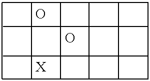

Having identified the move or moves to be made based on the reels results in step 210, three moves will be made on the tic-tac-toe game board in step 215. In the middle of the game board, an O is placed and in the lower left of the game board, an X is placed. An O is found on the reels in the space corresponding to the upper left space on the game board, however an X is already placed in that space on the game board. In the exemplary embodiment, the X on the game board will be replaced with an O, as shown in the resulting game board in Table 4.

TABLE 4

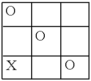

Continuing the example above, in step 220 the game board is analyzed and it is determined that there is a winning outcome: a diagonal set of Os from the top left to the bottom right of the game board. Accordingly, in step 225, one or more awards are presented to the player as a result of the winning outcome. The one or more awards may be associated with a diagonal winning outcome or the specific diagonal winning outcome of top left to bottom right.

The game board may be cleared before returning to step 210. The winning player may continue playing, but will not have the benefit of symbols collected in previous games. The symbols placed on the tic-tac-toe game board are cumulative, and the tic-tac-toe game is played across one or more rounds or games of the underlying base game. Thus, even if the base game is not producing winning outcomes, the tic-tac-toe game may produce one or more winning outcomes during a gaming session of the base game. For example, as one embodiment of the invention the tic-tac-toe game may comprise a bonus event to underlying slot or reel games. A player may wager to play each reel game. The player may or may not receive any winning outcomes as a result of playing the base reel games. However, as a result of the play of the reel games, the player might achieve a win of the tic-tac-toe game and be awarded an award, such as monetary winnings (a fixed amount, jackpot, etc.). In this manner, the player is enticed to play multiple base games in an attempt to obtain a winning tic-tac-toe outcome.

As indicated herein, the games of the invention may have other configurations or be presented in other manners. For example, in one embodiment, a player might be awarded for winning tic-tac-toe outcomes of any type. In other embodiments, a player might be required to select a symbol, such as X or O. The player would then only be a winner if the selected symbol formed a winning outcome. In such a configuration, the house or another player might then play the other symbol and a win by the house or other player might clear the tic-tac-toe board, thus forcing the player to start over.

In one embodiment, players might play head to head. For example, two or more gaming machines might be linked. Each machine might display the same tic-tac-toe board or might be linked to a common board. The players might be assigned or select different symbols. Tic-tac-toe symbols received by both players might be placed on the common board or only the symbol selected by the player might be placed on the common board (for example, if Player 1 selects X and then receives both O and X symbols in plays of their main game, only the X symbols would be posted; whereas in other embodiments, all symbols might be placed), wherein each player attempts to achieve a win of their selected symbol.

As indicated herein, the tic-tac-toe game of the invention might comprise a stand-alone type game, a multi-player game, a bonus or secondary event/game or a “game in game” feature of a main game. The tic-tac-toe game might also comprise a promotional game or event. For example, in certain embodiments, tic-tac-toe symbols might be awarded or placed based upon a player's wager, a player's pay of a main game (for example, as described below, a symbol might be awarded or placed as part of a bingo game outcome or event), a player's achievement of a main game feature (for example, certain main game outcomes might generate a tic-tac-toe symbol).

As indicated above, the tic-tac-toe type event may comprise a secondary event to a base game or comprise an entertaining display of a base game or event. For example, in one preferred embodiment, a base game may comprise a bingo game. The results of such a game may be displayed by a tic-tac-toe type event of the present invention. In one embodiment, the outcome of the bingo game may be displayed by an entertaining reel-type event which itself has an associated tic-tac-toe secondary event (wherein the tic-tac-toe event is secondary to the reel event, but both the reel event and tic-tac-toe event comprise an entertaining display of the outcome(s) of the underlying bingo game). Pre-determined outcomes of the bingo game may be associated with reel game outcomes and associated tic-tac-toe symbols and game board spaces, such that a random outcome in the bingo game produces one or more moves in the tic-tac-toe game.

As one example, in a step S1 a player purchases a bingo card or places a wager. As indicated above, such may comprise a player providing a number of credits at a gaming machine. This step might also comprise a player providing monies to an operator. Relative to the game of bingo, a player may be permitted to purchase bingo cards having different values, such as “base” value cards (such as “one credit” cards) or higher value cards, such as “max” value cards (purchased for two or more credits). The particular purchase prices or values of the cards may be determined by the operator.

One or more bingo or game cards are assigned to the player in a step S2. In one embodiment, a player might purchase two or more cards, and such cards may be assigned to the player. The game cards may be provided electronically. For example, relative to the system illustrated in FIG. 1, upon a player placing a wager, a server 130 may assign a game card to a player and transmit game card information to the gaming machine 100 that the player is playing. This game card may be displayed to the player at the gaming machine.

The bingo or other game card may have various configurations. Preferably, the game card bears numbers or other designations. For example, the card might comprise a bingo card having numbers arranged in a 5 by 5 grid (totaling 25 numbers arranged into five rows and five columns). The numbers on the cards might comprise numbers selected from the group of numbers 1-75, which numbers are randomly assigned to the locations of the card. In some embodiments, numbers from the group 1-15 are randomly selected for the 5 spots of the first column, numbers from the group 16-108 are randomly selected for the 5 spots of the second column, etc. for each card. One card could have the numbers 1-75 may be associated with columns designated “B” “I” “N” “G” and “O” and balls or objects may be similarly marked (such as B5; N42, etc.)

In one embodiment, certain criteria may have to be satisfied before a game can be initiated. For example, in a bingo-type game, two or more players may be required before a game can begin. Thus, two or more players may be required to purchase game cards or place wagers before the game begins.

When the game begins, one or more objects which are similarly numbered or designated as the game cards are drawn or selected, as in a step S3. In one embodiment, objects may comprise bingo balls, either in electronic or physical form, which are numbered with the numbers one to seventy-five (1-75). The balls or other objects may be physical objects or may be electronically represented.

When the game is presented via a gaming machine, such as by the system illustrated in FIG. 1, various of the steps of the invention may be performed by the gaming machine and/or server. For example, the game server (e.g., server 130) may be configured to generate game cards, randomly select balls or game numbers, track and display matches of game numbers to game cards, and confirm whether a player's eligibility for a win. In such a configuration, steps of the game might be implemented via machine readable code which is stored at a memory of the gaming machine and executed by the controller of the gaming machine.

In one embodiment, the objects may be selected in one or more sets or “draws”. For example, in one embodiment of a game, there is a first single ball draw of thirty (108) numbers or designations which may be represented as balls. In another embodiment, there is a first draw of one (1) number or designation and then a second ball draw of twenty-nine (29) numbers or designations.

In the game of bingo, the numbers or other designations associated with the objects are compared to the numbers or designations on the cards to determine matches and potential wins, as in a step S4. It is noted that the process of matching may require input from the player (such as requiring a player to place a “daub” button), and may be required relative to each group or draw of numbers or designations (for example, the player may be required to “daub” after a first single numbers or designation is drawn and then again after the 29 additional numbers or designations are drawn, relative to the example ball draw indicated above). The comparison may be accomplished automatically or manually. For example, a player might select a “daub” button to affect the gaming machine's marking of all matches of drawn or called numbers or designations to those on each of their cards. In other embodiments, such might occur automatically or the player might be required to mark each match.

In one embodiment, one or more predetermined game outcomes are determined to be winning outcomes. In a game of bingo, the winning outcomes may be particular patterns of matches of the numbers or other designations on a card, such as a diagonal, horizontal or vertical line of player numbers, an “X” pattern or the like. The one or more predetermined winning combinations may have prizes associated therewith, as in the step S4. One or more winning combinations may be deemed “game ending” patterns in that once received, they cause the game to terminate or bring the game to an end, as in a step S5 (the other winning outcomes may be termed “interim” winning outcomes or patterns, since they result in win to the player, but do not end the game). As part of the determination of winning outcomes, associated prizes may be awarded.

Thus, during the course of game play, one or more players may receive interim winning outcomes based upon matches of their card(s) to the one or more initial ball draws. In addition, one or more players might receive the game ending pattern based upon the one or more initial ball draws. As indicated, one or more additional balls may be drawn until a game-ending pattern is received.

In one embodiment of the invention, the outcomes of the bingo game may be represented by other entertaining events. For example, the bingo game outcomes might be represented as a reel-type event having a secondary tic-tac-toe event. For example, a losing bingo game outcome might be presented as a reel-type event where reels spin and display symbols which do not result in a winning outcome/combination of symbols. A first winning bingo game outcome might be presented as a reel-type event where the reels spin and display symbols which represent a particular winning combination of symbols and an associated award. A second winning bingo game outcome might be represented reel-type event where the reels spin and display symbols which represent a different winning combination of symbols and an associated award. Of course, various of the representative reel-type outcomes may also include the display of one or more tic-tac-toe symbols. The outcomes of the tic-tac-toe event may thus comprise a representative award of the base bingo game. In other embodiments, however, the tic-tac-toe event might result in awards which are separately from the base bingo game (such as a bonus award).

As one example, a base bingo game win might have an associated award of 100 credits. That award might be represented by a reel-type game event which displays symbols which correspond to a 75 credit win and then results in completion of a tic-tac-toe game having an associated award of 25 credits.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. For example, while reel-based and bingo-based games have been referred to throughout, other applications of the above embodiments include online or web-based games, card-based games or games or wagering events.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention.

The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gaming machine comprising a controller configured to:
provide a base game;
display a tic-tac-toe game board that comprises a plurality of spaces;
identify, based at least in part on an outcome in the base game, one or more moves to be made on the tic-tac-toe game board;
place one or more tic-tac-toe symbols in spaces on the tic-tac-toe game board based on the identified moves to be made such that if the space includes a previously-placed tic-tac-toe symbol, the previously-placed tic-tac-toe symbol is replaced; and
determine if the tic-tac-toe symbols define a winning outcome.

2. A gaming machine in accordance with claim 1, wherein the base game includes a plurality of reels that each include a plurality of symbols, each of the plurality of symbols being in a position on the plurality of reels, each position corresponding to a space on the tic-tac-toe game board.

3. A gaming machine in accordance with claim 2, wherein the controller is further configured to spin the plurality of reels.

4. A gaming machine in accordance with claim 3, wherein identifying one or more moves comprises identifying one or more moves to be made on the tic-tac-toe game board based on the position of each symbol on the plurality of reels.

5. A gaming machine in accordance with claim 1, wherein the base game is a bingo game.

6. A gaming machine in accordance with claim 1, further comprising a first display, wherein the controller is further configured to display the base game using the first display.

7. A gaming machine in accordance with claim 6, further comprising a second display, wherein the controller is further configured to display the tic-tac-toe game board using the second display.

8. A gaming machine in accordance with claim 1, wherein determining if the tic-tac-toe game board includes a winning outcome comprises determining if the tic-tac-toe game board includes a pre-determined pattern of tic-tac-toe symbols.

9. A gaming machine in accordance with claim 8, wherein the pre-determined pattern of tic-tac-toe symbols includes at least one of a horizontal, vertical, and diagonal line.

10. A gaming machine in accordance with claim 1, wherein the controller is further configured to clear the tic-tac-toe game board if the winning outcome is determined.

11. A machine-implemented method of presenting a game at a gaming machine, the method comprising:
providing a tic-tac-toe game board that comprises a plurality of spaces;
accepting a wager from at least one player to play a game;
spinning, after accepting the wager, a plurality of reels that each include a plurality of symbols, each of the plurality of symbols being in a position on the plurality of reels, each position corresponding to a space on the tic-tac-toe game board;
identifying one or more moves to be made on the tic-tac-toe game board based on the position of each symbol on the plurality of reels;
placing one or more tic-tac-toe symbols in spaces on the tic-tac-toe game board based on the identified moves to be made such that if the space includes a previously-placed tic-tac-toe symbol, the previously-placed tic-tac-toe symbol is replaced; and
determining if the tic-tac-toe symbols define a winning outcome.

12. A machine-implemented method of presenting a game at a gaming machine, the method comprising:
providing a tic-tac-toe game board that comprises a plurality of spaces;
providing at least one bingo card bearing numbers or other designations associated therewith;
drawing at least one first set of bingo balls having associated numbers or designations and comparing the bingo balls to the numbers or designations associated with the bingo card;
identifying one or more moves to be made on the tic-tac-toe game board based on the comparison of the bingo balls to the numbers or designations associated with the bingo card;
placing one or more tic-tac-toe symbols in spaces on the tic-tac-toe game board based on the identified moves to be made such that if the space includes a previously-placed tic-tac-toe symbol, the previously-placed tic-tac-toe symbol is replaced; and
determining if the tic-tac-toe symbols define a winning outcome.

13. A machine-implemented method of presenting a tic-tac-toe type event, the method comprising:
providing a tic-tac-toe game board that comprises a plurality of spaces;
identifying one or more moves to be made on the tic-tac-toe game board based on at least one randomly generated outcome, wherein each of the one or more moves includes a selection of a tic-tac-toe symbol and a selection of one of the plurality of spaces;
placing one or more tic-tac-toe symbols in spaces on the tic-tac-toe game board based on the identified moves to be made such that if the space includes a previously-placed tic-tac-toe symbol, the previously-placed tic-tac-toe symbol is replaced; and
determining if the tic-tac-toe symbols define a winning outcome.
